(19) United States
(12) Patent Application Publication
(10) Pub. No.: US 2024/0416380 A1
(43) Pub. Date: Dec. 19, 2024

(54) RESIN APPLICATOR FOR COATING METAL WIRE AND ASSOCIATED METHOD FOR COATING

(71) Applicant: NV Bekaert SA, Zwevegem (BE)

(72) Inventors: Jonas EGGERMONT, Waregem (BE); Jianhui (Kevin) GONG, Zwevegem (BE)

(73) Assignee: NV Bekaert SA, Zwevegem (BE)

(21) Appl. No.: 18/706,112

(22) PCT Filed: Nov. 3, 2022
(86) PCT No.: PCT/EP2022/080713

§ 371 Date: Apr. 30, 2024

(30) Foreign Application Priority Data
Nov. 10, 2021 (EP) 21207584.0

(51) Int. Cl. B05C 1/14; B05C 11/02; B05C 11/10; B05C 15/00

(52) U.S. Cl. CPC B05C 1/14; B05C 11/021; B05C 11/101; B05C 15/00

(57) ABSTRACT

An applicator for coating metal wire with resin, an associated method for coating resin on metal wire, and an installation containing the applicator while using the method. The apparatus that contains an applicator for applying an resin solution and a wiping section, wherein the distance between these two can be adjusted as well as the length of the wiping section. The applicator applies a surplus of resin solution, while the wiping section calibrates this to the desired amount in order to obtain the final amount of dried resin on the wire. Both applicator and wiping section are contained in an encasement with provisions to recuperate evaporated solvent thereby reducing harmful emissions. In the associated method the resin to solvent ratio is used to steer to the final amount.

### TECHNICAL FIELD

The invention relates to the field of coating metal wires, in particular steel wires, with a resin coating. An apparatus, an installation and a method is described and claimed.

### BACKGROUND ART

In industry, metal wires sometimes need to be covered with a resin that is subsequently cured to form a polymer coating. Typical products are e.g. copper wires that are lacquered with a thin insulating resin for use in electrical spools, resin coated low carbon wires for holding corks on bottles containing pressurised beverages, high carbon steel wires that are coated with a resin to improve green tack to rubber in the beads of a tire. The latter—commonly called ‘bead reinforcement wire’ or simply ‘bead wire’—is the product of focus of the method and apparatus described in this publication, although the method, installation and apparatus is equally well suitable to produce the other mentioned products.

Tires are held on the wheel rim by means of two hoops made of ‘bead wires’ that are coiled into what is called a ‘bead coil’ or ‘bead’ in short. In order to make the bead coil adhere to the rubber during the confectioning of a tire, the steel wire that is used to coil the bead is covered with a resin that improves the ‘tack’ or ‘stickiness’ of the bead coil to the uncured rubber. This form of adhesion is called ‘green tack’. During the curing of the tire at higher temperatures, this resin melts and is absorbed into the rubber. In order to ensure a good adhesion between the bead coil and the bead rubber surrounding the bead coil, the steel wire used has a bronze or sometimes, in special applications, a brass coating. Bronze is an alloy of copper with some tin (about 1 to 10 wt % of tin), brass is an alloy of copper with zinc (with a copper amount of about 60 to 70 wt %).

The resins used for covering the bead wire are pretty much standardized and are generally referred to as ‘coumarone-indene’ or ‘coumar’ or ‘cumar’. This is a mixture of coumarone with IUPAC name ‘benzofuran’ and indene. These are polycyclic hydrocarbons with a benzene ring fused with a cyclopentene ring. They are thermoplastic resins that are solid at room conditions. Coumarone and indene are extracted out of coal tars. The resin is dissolved in an organic solvent. The resin solution is applied to the steel wire and subsequently dried to remove the solvent.

One of the problems faced by the bead wire industry is that it is difficult to obtain an evenly spread coating of coumarone on the wire itself. In order to do this in an efficient way this is done on run-through installations wherein a plurality of wires (12 to 72 or more) are running at relatively high speed. First a thermal annealing treatment is given to the wire to adapt the wire mechanical properties notably to increase the plastic elongation of the wire. Next, the wire is cleaned and coated with a bronze or a brass coating. Again after cleansing, the wires are coated with the resin solution. Thereafter, the solvent is dried out of the coating in order to close the resin on the wire.

The current systems for coating the wires with the resin solution mainly make use of cotton wicks that are wound around the moving wire. The cotton wicks are saturated with solution by pouring solution over it and/or keep them wet through capillary action. However, such systems are not always very reliable, tend to be operator dependent and right out dangerous as the wick can be carried by the wire. Furthermore, the evaporation of the usually inflammable solvent results in a hazardous fumes for both human beings and the environment.

CN105057160A discloses a system for coating bead wire with a resin. However, it is also based on wicks in a single one coating section.

EP3473419A1 is a worthwhile attempt to replace the wicks with a rotating wiper axis. The wiper axis is provided with a stack of circular pads, that turns partwise in a bath of resin solution. The wires run between the pads thereby being wetted and coated with solution and at the same time the solution is wiped and smeared over the circumference of the wire. The amount of coating can be controlled through adapting the rotational velocity of the axis. However, this system is rather complex.

The inventors therefore set them selves the task to improve the current praxis and to develop an apparatus that results in a better controllable resin coating and at the same time improve operator working conditions and volatile organic compounds (VOC's) emissions.

### DISCLOSURE OF INVENTION

The main object is to eliminate the problems of the past. One object of the invention is to present an apparatus that allows for a better control of the coating amount. Further the apparatus results in a better environmental control of VOC emissions. Another object of the invention is to provide a method to coat wires with resin. A final object is to provide an installation for coating multiple wires at high speeds.

According a first aspect of the invention an apparatus according the features of claim 1 is described. The apparatus is for coating one or more, plane parallel wires with a resin solution. That is: the wires run parallel at high speed through the apparatus, they form a web. The number of wires is from one to hundred twenty, more preferred from twelve to seventy two. The wires are steel wires although this is not a limitation of the invention: the apparatus can equally well be used for coating other wire materials such as copper, copper alloy, aluminium or aluminium alloy or other manmade wires such as glass fibre rod or carbon rod. Indeed: the apparatus does not apply any bending on the wires, that is the wires go straight through, which is an advantage.

Characteristic about the apparatus is that the apparatus comprises an applicator and a wiping section. These are separated components and the distance between the applicator and the wiping section can be adjusted. With the latter feature is meant that the distance between applicator and wiping section can be set at discrete distances to one another or that the apparatus is provided with a system to continuously change the distance. The distance between applicator and wiping section must be variable in order to be able to coat wires of different diameters with different amounts of coatings per surface unit. By this feature, different wire diameters ranging from 0.25 to 2 mm, or from 0.50 to 1.50 mm can be coated with different final amounts of resin.

The final amount of resin can be varied from 50 to 300 mg/kg or even from 100 to 200 and can be controlled within a range of 50 mg/kg. The final amount of resin is determined by double weighing: first an amount of coated wire is sampled and accurately weighed. Then the resin is removed by flushing the wire in a hot stream of solvent (e.g. in a Soxhlet extractor) and the sample is weighed again. The difference in weight (in mg) is divided by the original weight of the sample (in kg).

An alternative method to determine the final amount of resin is to dissolve the resin of a weighed mass of wire in a known volume of cyclohexane. The concentration in this solution is determined by means of ultra-violet absorption spectrometry. The resin exhibits a maximum in absorbance at a wavelength λₘₐₓ. By comparing the absorbance of the unknown solution with a standard solution of resin the unknown concentration can be determined via Beer's law:

$$E = - Log ( \frac{{I}_{i}}{{I}_{t}} ) = k \cdot c \cdot L$$

Wherein:
E is absorbance in arbitrary units;
Iᵢ is the intensity of the incident ray;
Iₜ is the intensity of the transmitted ray;
k is the specific absorbance coefficient, that is the absorbance of a standard 1 gram per litre solution;
c is the concentration of the sample solution to be measured;
L is the optical length of the sample holder.
   Out of the measured concentration ‘c’ the mass of resin on the known mass of wire can be calculated.

According a preferred embodiment of the apparatus the applicator comprises a container, a box, with slots for guiding the one more wires through: at the one side the wires enter through the entrance slot and at the opposite side, the wires exit the container through the exit slot. The container is preferably made out of metal plate, for example stainless steel, or a polymer such as PVC or PE. The container preferable has the shape of a rectangular box with a length about equal to the resin application length and a width sufficient to cover the wire web width.

The container has a permeable bottom and a permeable cover. These covers can be realised e.g. by a foraminated plate, that is a plate with small holes in it, or a sieve or an expanded metal plate. The bottom holds the bottom felt in place. The cover holds a top felt in place. The cover is used to push the bottom and top felt against one another with a controlled pressure. The pressure can be controlled by a weight on the top cover, a lever system or spring pressure system, or a pneumatic actuator or the like.

The meaning of the term ‘felt’ should be construed broadly: it is a nonwoven fabric material made natural or manmade fibres. In this case the ‘felt’ is pressed into a thick sheet of several millimetres thick. The felt may be made of short or long fibres or mixtures of both. Typical preferred fibres are natural fibres such as wool, cotton, hemp, sisal or mixtures there off. Manmade fibres such as rayon or PET (polyethylene terephthalate), or PP (polypropylene), can also be used, but are less preferred.

The fibres are mechanically compressed, possibly after being needle punched, and possibly with the admixture of an adhesive. However, in this the use of adhesives in the felt is not preferred to prevent interaction with the solvent. Important is that the felt has the right specific air volume in order to allow soaking by the resin solution thereby retaining some of the solution by capillary action while letting through sufficient flow. A density of between 5 to 200 grams per cubic decimetre or from 10 to 100 grams per cubic decimetre has been found to be adequate. The felt is provided in brick size dimensions, fitting the container cross section.

In a further preferred embodiment, the apparatus is equipped with a resin solution piping for feeding and soaking the top felt and bottom felt with resin solution. The resin solution is poured on top of the permeable cover, penetrates the top felt and bottom felt and is drained through the bottom cover where it is collected in a sump for further circulation. A fixed level of resin solution is kept on top of the permeable cover by means of an overflow system. The overflow connects to the sump where all resin solution is collected and fed to a buffer tank for further circulation.

In a further preferred embodiment the wiping section is made up of one, two, three, or more wiping zones. Each wiping zone has a bottom and top wiper felt. The top wiper felt is pushed onto the bottom wiper felt by means of a weight, a lever, spring system or similar contraption. The length of the wiping section can be adjusted by adding more or less wiping felts in the wiping zones;

The applicator and wiping section cooperate: the applicator ensures that enough resin solution is present on the wire surface while the wiper section firstly homogenises the presence of the solution over the whole circumference of the wire and secondly controls the amount of resin solution remaining on the wire. This remaining amount of resin solution can be controlled by either varying the distance between applicator and wiping section or by varying the length of the wiping section or both. The amount of resin solution on the intermediate wire relates linearly to the amount of resin on the final product.

In a further preferred embodiment, the applicator and wiping section are placed inside an encasement, a housing, a box. The encasement prevents loss of resin solution by splatting and contains the solvent fumes. These solvent fumes are harmful, inflammable and noxious to the environment. Therefore the encasement is provided with an active fume exhaust that is a fan or cyclone that sucks the air fume mixture out of the encasement. These fumes are led through an afterburner to annihilate any harmful effect of the fumes and burn the evaporated solvent in a controlled way. The encasement is not airtight as slots are provided for the passage of the wires. The active fume exhaust guarantees a lower pressure in the encasement compared to outside the encasement preventing solvent fumes to exit the encasement.

In a further preferred embodiment the encasement can be filled with a controlled atmosphere on demand. For example if there is only the slightest indication of a fire, the encasement can be filled with carbon dioxide gas in order to deprive the flames of oxygen.

In a further preferred embodiment, the encasement contains a condenser. With ‘condenser’ is meant a cooled body, kept inside the encasement on which the solvent fumes condense and can be recuperated for further use. This in addition or as an alternative to the presence of an active fume exhaust.

In a further preferred embodiment the active fume exhaust extract the fumes from the bottom side of the encasement. Indeed, sucking the fumes upwardly may, from an engineering standpoint, be the easiest as these fumes can be led to the roof and then out of the workplace, but that means fumes have to be dragged throughout the encasement. While extracting fumes from the bottom is more difficult to realise, the fumes are dragged according their natural tendency of going downward as they form a mist hence, are heavier than air.

One advantage of the inventive apparatus is that it limits the free surface of resin solution and hence unwanted evaporation of the solvent. With ‘free surface’ is meant the reachable by air that is not saturated with solvent. Indeed, solvent evaporation results in an increasing resin concentration in the solvent solution during processing and hence in an increasing final amount of resin on the wire. Solvent evaporation thus makes it more difficult to control the final resin amount. As the above described apparatus has very little open surface, the variation due to solvent evaporation is minimised.

In a further preferred embodiment of the invention the apparatus is further provided with a buffer tank for containing the resin solution. The resin solution is circulated to the applicator by means of a pump. Measuring instruments such as a density meter for determining the concentration of the resin in the resin solution of the buffer tank and a level meter for measuring the level in the buffer tank are added. The concentration in the buffer tank relates to the ratio of the resin to the solvent. Further, a solvent tank for adding solvent through an associated solvent valve, a resin tank for adding high concentration resin solution through an associated resin valve and a controller are present. The density meter and the level meter are inputs to the controller. The output of the controller controls the solvent valve that releases solvent from the solvent tank into the buffer tank as a first output and controls the resin valve that releases high concentration solution from the resin tank. Based on the input of the density meter and the level meter, the resin valve and/or the solvent valve are opened by the controller when the concentration becomes too low and/or the concentration becomes too high. In any case the level of the buffer tank will decrease during operation as the resin solution is consumed, dragged away by the moving wire web. Both solvent valve and resin valve close when the level meter indicates a maximum level. The controller has the capability to steer the resin to solvent ratio to a set level.

In a further preferred embodiment of the apparatus in all its possible combinations and variations as described so far is equipped with a buffer tank, a continuous or discontinuous measurement probe for determining the resin concentration in the resin solution, a solvent addition tank and a resin addition tank and a feeding system. The resin addition tank can for example be filled with a high concentrate resin solution. The measurement probe can be a measuring device based on buoyancy, or an infrared based device or a refractometer. The feeding system adds solvent to the buffer tank, or resin to the buffer tank or both or none of the two based on the measurement of the measurement probe.

The above described apparatus is for coating steel wires with coumarone-indene resin for use in beads of tires.

According a second aspect of the invention an installation for coating multiple, plane parallel wires with resin comprising the apparatus described here before is also part of the invention. More in particular an installation for producing bead wire comprising the apparatus described here before is claimed.

Such a bead wire installation typically comprises:
A pay-off section for delivering several steel wires in parallel;
A degreasing section for cleaning the steel wires' surface;
A thermal treatment to anneal the steel of the steel wires;
A pickling and rinsing step to activate the surface of the steel wires;
Plating the wire surface with bronze out of an electroless bronze plating bath;
Coating the wire with coumarone-indene resin by means of the above described apparatus;
Winding the resin coated steel wire—called bead wire—on a spool for further processing to a tire bead.

According a third aspect of the invention, a method to coat one or more parallel steel wires with a resin solution with the above described apparatus is claimed. The method comprises the steps of:
Providing a continuously moving web of one or more plane parallel wires. Preferably the wires are steel wires that are unwound from a set of spools under controlled tension;
Providing a resin solution comprising resin dissolved in a solvent according to a resin to solvent ratio. Preferable the resin solution is held in a buffer tank for ease of supply;
Applying the resin solution to the plane parallel wires in the applicator in a surplus amount larger than a desired amount. In other words: it must be ensured that more than enough resin solution is provided on the wire, but also not too much. A surplus of 5 up to 50% over the desired amount is aimed for, more preferred from 5 to 25% or even 5 to 10%;
In the wiping section, the excess amount of resin solution is removed. The wire now has the desired amount of resin solution on the wire;
The wire is then dried in order to remove the solvent from the resin solution. Typically, less than 5% or even less than 2% of the coating weight is still present as a solvent. Preferably the presence of the solvent can be traced, but cannot be measured. This can be assured by heating the wire in an oven above the solvent vaporising temperature and make an accurate double weighing, prior vs after heating. After proper drying, the final amount of resin present on the wire is set;
Finally the coated wires are wound on carriers.
   The surplus amount, the desired amount and the final amount of resin must be considered relative to the same unit that may be the same mass of steel wire or the same of steel wire surface or the same amount of length of wire.

Characteristic about the method is that the final amount of resin is adjusted by changing the resin to solvent ratio. In case the final amount of dried resin is too low, more resin is added to the resin solution (e.g. from a highly concentrated master batch). A contraire when the final amount of dried resin is too high, more solvent is added to the resin solution. Possibly the amount of resin in the solvent is measured continuously for example by means of a buoyancy meter, infrared metering probe or a refractometer. The measurement can be used as feedback to a feeding system that steers addition of a highly concentrated master batch or adds solvent to the solution or does both or does nothing. This method allows for a greatly improved final resin amount control over the complete length of the wire.

If the steering window reachable by adjusting the resin to solvent ratio turns out not to be sufficient to obtain the desired amount of resin, the amount can also be adjusted by changing the distance between the applicator and the wiping section in addition to the controlling of the resin to solvent ratio. If the distance between the applicator and the wiping section is too low, the amount of resin solution present on the wire becomes too low. If the distance between the applicator and the wiping section is too high, there is a risk for lump formation that is the coating is not homogeneously applied. The optimum distance between applicator and wiping section depends on wire diameter and line speed.

Alternatively or in combination with adjusting the distance between applicator and wiping section, the length of the wiping section can be adjusted. Adjustment of the wiper section length can be done by adding or removing wiping zones. A shorter wiping section will result in a final amount of resin that is higher, a longer wiping section will result in a final amount of resin that is lower.

A further parameter that has an influence on the final coating amount on the wire is the line speed. But the line speed is dictated by other process steps in the lines e.g. the thermal treatment or the metallic coating step. Hence, line speed cannot be used to control the final amount of resin on the wire.

As a solvent the following can be considered:
non-polar solvent out the group comprising aromatic hydrocarbons such as benzene, methylbenzene (commonly called toluene), dimethylbenzene (common name: xylene);
moderate polar aliphatic solvents such as gasoline, propanone (that is ‘acetone’), methyl acetate, ethyl acetate, propyl acetate, butyl acetate, diethylene glycol diethyl ether;
polar solvents such as alcohol or water;
   The choice of solvent goes together with the type of resin that is to be applied.

The resin itself is an aromatic hydrocarbon resin or a phenolic resin. Most preferred resin is coumarone-indene that is the preferred resin for coating bead wire in order to improve green tack. This resin is preferably dissolved in a moderate polar aliphatic solvent e.g. gasoline.

The wires that are preferably coated by the method are steel wires that have already been coated with a metallic coating in order to improve adhesion to rubber. The steel wires have a diameter ranging from 0.5 mm to 2.0 mm, or from 0.50 to 1.50 mm. Smaller diameter wires or wires made of a material that has a modulus that is lower than that of steel are less preferred: these wires are much to easily bendable and the surface area to be coated is not in balance with the method suggested for coating the wire. Such wires are better coated in a series of baths containing solvent solutions with subsequently larger dies as is known in the lacquering industry. However, these methods are considered not suitable for coating a plurality of parallel wires running next to one another.

The metallic coating comprises one or more metals or metal alloys out of the group comprising, bronze, brass, copper, zinc, cobalt, nickel, iron, manganese, tin, silver.

### BRIEF DESCRIPTION OF FIGURES IN THE DRAWINGS

FIG. 1 shows a schematic view of the apparatus.

FIG. 2 shows the applicator in detail.

FIG. 3 shows a schematic of a coating installation.

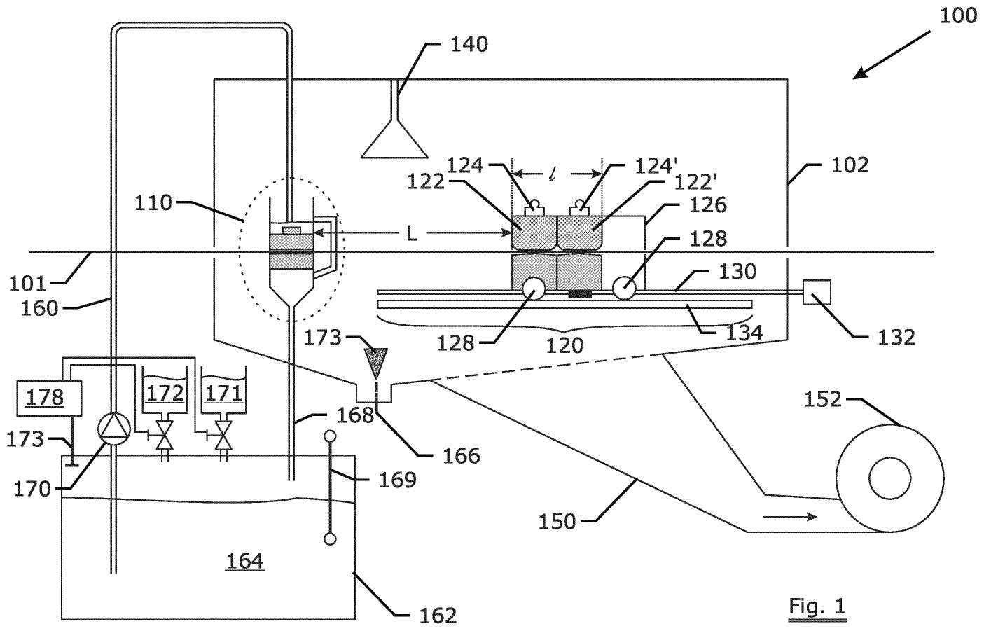

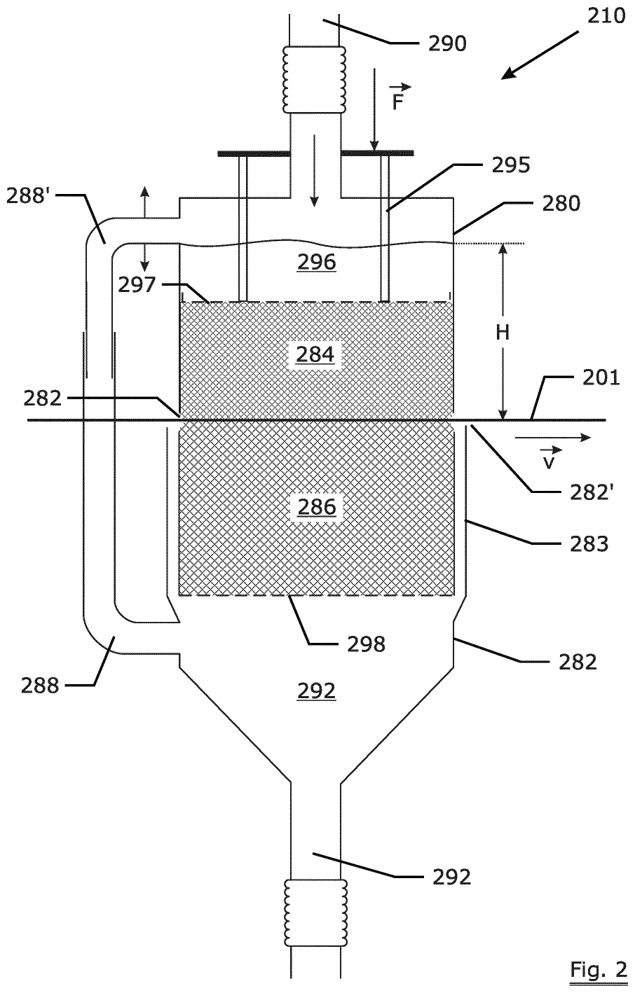

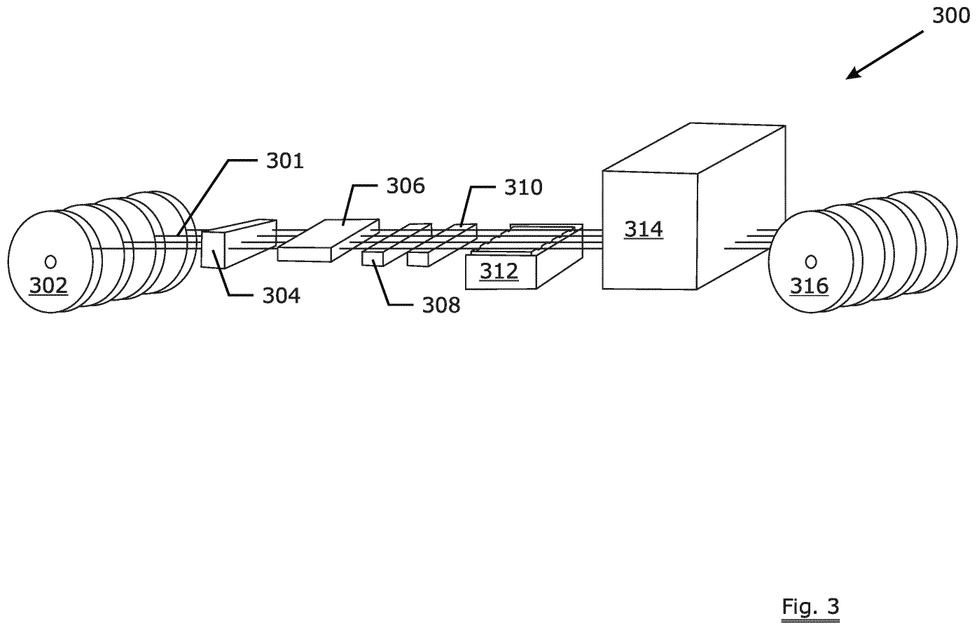

Hundred digits of the reference numbers refer to the figure number, tens and units refer to identical features across figures for FIGS. 1 and 2. References in FIG. 3 are independent from those of FIGS. 1 and 2.

### MODE(S) FOR CARRYING OUT THE INVENTION

FIG. 1 show the inventive apparatus 100 that consists of an applicator 110 (explained later on) and the wiping section 120. Both items are situated in an encasement 102. The wire web 101—shown in the plane of the web—travels from the entrance slot to the exit slot of the encasement 102, hence the encasement 102 is not airtight.

The wiping section 120 consists of three wiping zones on a cart 126 of which the first two are shown with felt pairs 122 and 122′. A felt pair consists of a bottom and top wiper felt. The total length of the wiping section is indicated with ‘l’. The cart 126 is mounted on rails 134 and four wheels 128, 128′ and can be driven lengthwise to the wire web 101 via a threaded rod 130 driven by motor 132. In this way the distance ‘L’ from applicator 110 to the wiping section can be easily and conveniently adjusted. The pressure on the felts is held by means of the masses 124, 124′ put on the top felt. The inventors have found that the amount of pressure exerted by the felts does not have a big influence on the effect of wiping.

The applicator 210 is shown in more detail in FIG. 2. It primarily comprises a container 280 of rectangular cross section. The wire bed 201 enters through entrance slot 282 and exit slot 282′ at speed v′, thereby dividing the container 280 in a lower part and an upper part. In the lower part, a foraminated plate 298 is fixed to the walls of the container 280. The plate 298 contains holes in a number and size that is sufficient to ensure flow of the resin and proper support of the bottom felt 286.

In the upper part of the container 280, the top felt 284 is pressed by a foraminated plate 297 against the wire web 201. Pressing can be exerted via rods 295 on which a force F is applied. On the top felt 284, resin solution is poured through feed line 290, thereby forming a volume 296 of resin solution above the top felt. The resin percolates through the felts 284 and 286 and is caught in sump 292. The height ‘H’ above the wire web controls the flow rate of the resin solution. The height ‘H’ is set through the overflow tubing 288′ that can be moved up or down relative to the container wall and feeds into tube 288 that ends in the sump 292 of the container 280. Also the lower part of the container 280 is provided with a catch 283 to collect any superfluous resin solution escaping the slots of the container 280.

Turning back to the overall view FIG. 1, the encasement 102 is provided with an active exhaust system with a collecting funnel 150 ending in a cyclone extractor 152. Contrary to the general accepted design that fume extraction is done at the upper side of the encasement 102, the inventors chose to provide the exhaust system at the bottom of the encasement 102. Although this leads to more complex piping, the advantage is that fumes are not drawn upwardly.

Further a fire extinguishing system 140 is provided in the encasement 102: when a fire emerges carbon dioxide gas is massively injected into the encasement 102 thereby driving the oxygen out. The encasement is further provided with a condenser 173 of which the temperature is kept below the dew point of the solvent of the resin solution. The solvent fumes condense on the condenser and solvent is recuperated in the sink 166.

The described apparatus can be made part of a bead wire installation 300 as depicted in FIG. 3. There the wire web 301 is formed by unwinding pay-off spools 302 with bare steel wire. First the wires are degreased in a degreasing tray 304 e.g. by means of steam. Thereafter a thermal treatment 306 follows to give the wires the desired mechanical properties (e.g. a decreased yield point). Thereafter a pickling step 308—to remove oxides—and a rinsing step 310 follows. Then the wire web is led through a plating bath 312 to electroless plate the steel wire with bronze. 314 is a block representation of the apparatus 100 to coat the wire with resin, in particular coumarone-indene resin, before it is wound on a customer spool 316.

The method to use the apparatus departs from the continuously moving wire web that runs with a speed indicated ‘\vec{v}’. The resin solution 164 wherein the resin is dissolved in the solvent is kept in a buffer tank 162 for ease of supply. Typically the coumaron-indene concentration in the solvent—the resin to solvent ratio—is between 1 and 10% by weight. There exists a quasi linear relationship between this concentration and the final amount of coumarone-indene found back on the coated wire.

In the applicator 110 the resin solution is applied to the moving wire web in a surplus amount. This surplus amount is larger than the desired amount that needs to be present after wiping. In the wiping section any superfluous resin solution is wiped off by the felt pad pairs 122, 122′ and the desired amount of resin solution remains on the wire. Thereafter the solvent is evaporated from the resin solution in a drying section (not shown). After the solvent has evaporated, the resin remains condensed on the surface of the wire and this in a final amount of resin. Usually this is expressed as a weight of resin divided by the total amount of wire. Typical values are between 50 and 500 mg/kg.

Specific about the method is that in the process, the final amount of resin on the coated wires can be adjusted, adapted, tuned, by changing the resin to solvent ratio. This ratio can be continuously monitored by means of a density meter 169 in the buffer tank 162 that contains the resin solution 164. The resin solution is circulated to the applicator by means of pump 170. If the concentration of resin becomes too low, the resin tank 172—containing a master batch resin solution—releases highly concentrated resin solution into the buffer. If the resin to solvent ratio reaches its upper control limit addition is stopped. At the other end, when the resin to solvent ratio becomes too high—because of increased evaporation of the solvent—additional solvent can be added out of the solvent tank 171. In any case an overall level meter 173 is present on the buffer tank 162 in order to prevent the tank from running empty or flowing over. The resin solution level measured by level meter 173, the concentration of the resin solution as measured by density meter 169, the closing and opening of the valves releasing resin from resin tank 172 or solvent from solvent tank 171 is all controlled through controller 178 The concentration control can limit the range (max-min) over the complete length of the wire below 50 mg/kg or even below 30 mg/kg.

Broader adaptations in function of diameter and line speed can be implement in the method by changing the distance ‘L’ between the applicator and the wiping section through motor 132. Or by increasing/decreasing the length ‘l’ of the wiper section.

The apparatus in combination with the method allows to control the application of resin on bead wire within very narrow ranges.

1. An apparatus for coating one or more, plane parallel wires with a resin solution, wherein
said apparatus comprises an applicator and a wiping section, wherein the distance between the applicator and the wiping section is adjustable.

2. The apparatus according to claim 1 wherein the applicator comprises a container with an entrance slot and an exit slot for guiding the one or more wires through, said container having a permeable bottom and a permeable cover, said bottom for holding a bottom felt, said cover for holding a top felt, said cover pressing said bottom felt and top felt with a controlled pressure against one another.

3. The apparatus according to claim 2 further comprising resin solution piping for feeding and soaking said top felt and bottom felt with resin solution through said permeable cover towards said permeable bottom and wherein the resin solution is held at fixed level above the top felt by means of an overflow system.

4. The apparatus according to claim 1 wherein said wiping section comprises one or more wiping zones, each wiping zone having a bottom and top wiper felt.

5. The apparatus according to claim 4 wherein the length of said wiping section can be adjusted.

6. The apparatus according to claim 1 wherein said applicator and wiping section are within an encasement, said encasement for containing solvent fumes emanating from said resin solution, wherein said encasement is provided with an active fume exhaust.

7. The apparatus according to claim 6 wherein said encasement can be filled with a controlled atmosphere on demand.

8. The apparatus according to claim 6 wherein said encasement further contains a condenser for condensing solvent fumes.

9. The apparatus according to claim 6 wherein the active fume exhaust extracts the fumes from the bottom side of the encasement.

10. The apparatus according to claim 1 that is further provided with a buffer tank, a solvent tank with solvent valve and resin tank with resin valve, a level meter and a density meter and a controller, said controller for controlling the solvent valve and/or the resin valve based on the input of the density meter and the level meter.

11. An installation for coating multiple, plane parallel wires with resin comprising the apparatus according to claim 1.

12. A method to coat one or more plane parallel wires with a resin solution with the apparatus according to claim 1, said method comprising the steps of:
providing a continuously moving web of one or more plane parallel wires;
providing a resin solution comprising resin dissolved in a solvent according a resin to solvent ratio;
applying said resin solution to said one or more plane parallel wires in the applicator in a surplus amount larger than a desired amount;
wiping off the resin solution in said wiping section to said desired amount;
drying the resin solution in a drying section to obtain one or more coated wires with a final amount of resin;
winding said one or more coated wires on carriers;
wherein
wherein the final amount of resin on the coated wires is adjusted by changing the resin to solvent ratio and/or by adjusting the distance between applicator and wiping section.

13. The method according to claim 12 wherein the desired amount of resin solution is set by adjusting the distance between the applicator and the wiping section.

14. The method according to claim 12 wherein the length of the wiping section is adjusted by setting the number of wiping zones to reach the desired amount of resin solution.

15. The method according to claim 12 where in the solvent is a non-polar solvent out the group comprising aromatic hydrocarbons such as benzene, methylbenzene, dimethylbenzene and moderate polar aliphatic solvents such as gasoline, propanone, methyl acetate, ethyl acetate, propyl acetate, butyl acetate, diethylene glycol diethyl ether and polar solvents such as alcohol and water.

16. The method according to claim 12 wherein the resin is an aromatic hydrocarbon resin or phenolic resin.

17. The method according to claim 12 wherein the wires are coated with a metallic coating, said metallic coating comprising one or more metals or metal alloys out of the group comprising, bronze, brass, copper, zinc, cobalt, nickel, iron, manganese, tin, silver.
